(19) United States
(12) Patent Application Publication
(10) Pub. No.: US 2017/0155274 A1
(43) Pub. Date: Jun. 1, 2017

(54) TOPOLOGY AND CONTROL STRATEGY FOR HYBRID STORAGE SYSTEMS

(71) Applicant: ROBERT BOSCH GMBH, Stuttgart (DE)

(72) Inventors: Jingting Cher, Singapore (SG); Annika Carolin Kufner, Neunkirchen am Brand (DE); Falco Sengebusch, Singapore (SG); Sumedha Chouthe, Singapore (SG); Xingchi Wang, Singapore (SG); Yanlin Li, Shanghai (CN)

(21) Appl. No.: 15/123,104

(22) PCT Filed: Mar. 3, 2014
(86) PCT No.: PCT/IB2014/059391

§ 371 Date: Sep. 1, 2016

(51) Int. Cl. H02J 7/35; H02S 40/38; H02J 7/00

(52) U.S. Cl. CPC H02J 7/35; H02J 7/0068; H02S 40/38

(57) ABSTRACT

A hybrid battery-charging device with input terminals for connecting a current source, first and second battery connections for connecting a lead-acid battery and a high-cycle chemical battery. A two-way DC/DC converter with first and second sets of terminals is connected with the second and first battery connections. A charge and discharge control system includes a controller unit, a control output for controlling the two-way DC/DC converter, and sensing inputs for sensing a charge state, an internal resistance of the lead-acid-battery and state of charge of the high-cycle chemical battery. The charge and discharge control system controls the two-way DC/DC converter such that the lead-acid battery is charged if its charge start is below a pre-determined threshold and that the high-cycle chemical battery is charged if its charge state is below a pre-determined threshold and if the state of charge of the lead-acid battery is above a pre-determined threshold.

### FIELD OF THE INVENTION

The application relates to a hybrid storage System for a remote energy System (RES).

### BACKGROUND INFORMATION

Historically, lead-acid batteries have been among the first rechargeable batteries. In 1859, the French physicist Gaston Plante had developed the first practically useful prototype. Nowadays lead-acid batteries are produced in a variety of types according to specific requirements such as price, life expectancy, robustness against environmental conditions, charging or discharging capabilities, recycling properties and weight. Lead-acid batteries are grouped into valve regulated lead-acid batteries (VRLA), also known as sealed lead-acid batteries (SLA), and refillable or flooded lead-acid batteries. There are two primary types of VRLA, gel cells and absorptive glass mats (AGM). In gel cell batteries, the electrolyte is thickened by addition of silica dust while in AGM batteries a fibreglass mat that takes up the electrolyte is inserted between the battery plates.

Lead-acid batteries have been used for years as the main storage medium in off-grid solar systems and in remote energy systems (RES) in general. The popularity of lead-acid batteries is mainly motivated by their low purchasing price. However, over the total lifetime of a RES, the lead-acid battery often becomes the main cost driver since it has to be changed every 1 to 3 years resulting in high costs for acquiring and changing several batteries. This relatively short lifetime, compared, for example, to lead-acid batteries in back-up systems, is due to the nature of remote energy applications. For example, in an off-grid solar system a battery is partly charged during daytime for several hours depending on the geographic location and on the weather and mainly discharged during night time, for example for running light bulbs, for running a TV set or other equipment and machinery. Due to these conditions, the lead-acid battery remains most of the time in a low state of Charge (SOC) and it is rarely fully charged. These aspects affect the capacity of a lead-acid battery since they tend to increase the sulfation process in a lead-acid battery.

During a typical discharge cycle of a gel cell battery, the voltage stays approximately constant and drops sharply towards the end of the discharging process. At the same time the internal resistance of the battery increases and rises sharply towards the end of the discharging cycle. Due to factors such as aging, low temperature, an undersized battery or a wrong battery technology a lead-acid battery may have a high internal resistance even if it is not at the end of a discharge cycle.

For many applications, it is necessary to determine the state of Charge (SOC) of the battery. In flooded lead batteries the electrolyte concentration can be used for this purpose. In dry batteries, the SOC is determined, among others, by measuring the open-circuit voltage, the internal resistance, by inductive measurements using an external coil, by determining the battery resonance frequency or by evaluating the electro-chemical noise of the battery.

Several mechanisms affect the life expectancy of a lead-acid battery. The anode is subject to grid corrosion, which is especially prominent for deep discharges, while the cathode is affected by sulphation and the electrolyte can be affected by water loss and acid stratification. In AGM batteries, the elasticity of the glass fibres decreases over time and the contact with the electrolyte deteriorates. In gel cell batteries, unavoidable water losses tend to thicken the electrolyte gel and this will eventually deteriorate the contact between the gel and the electrodes. Acid stratification mainly affects flooded lead-acid batteries and only to some extent the AGM batteries. Water loss affects the lifetime of gel cell batteries and is most pronounced when the battery is overcharged or is charged too fast.

Rechargeable lithium batteries are produced as lithium-ion and lithium polymer batteries. Lithium polymer batteries, which are also known as lithium-ion polymer batteries, have similar properties as lithium ion batteries but, different from lithium ion batteries, they do not contain a liquid electrolyte. Lithium batteries have a much higher energy density than lead-acid batteries and they can be discharged to a lower level. On the other hand, lithium batteries are sensitive against deep discharge and against overcharging and have a lower lifespan than other type of batteries. A deep discharge sets in when the battery voltage falls below about 2.5 Volt. Furthermore, lithium batteries with multiple cells connected in series require a cell balancing electronics.

During discharge of a lithium battery, the voltage falls off only slightly before the end of a discharge cycle is reached. The internal resistance, by contrast, decreases until about 60% of the capacity is reached and increases again when the battery is discharged further.

Various factors affect the lifespan of a lithium battery such as high temperatures, deep discharges, high charge or discharge currents and high charge voltages. While lead-acid batteries can last a long time if they are properly stored and recharged in regular intervals, lithium batteries age significantly during storage.

Patent document U.S. Pat. No. 6,353,304 discusses providing two battery strings, which can be connected to an AC power source via AC/DC converters and switches, such that one battery string is loaded while the other battery string is discharged. This arrangement can provide an improved battery management for solar hybrid systems that have a generator besides the solar cells.

### SUMMARY OF THE INVENTION

It is an objective of the present application to provide an improved hybrid storage system and improved methods for charging and discharging batteries of the hybrid storage system. These objectives are addressed by the independent claims. Further developments are disclosed in the dependent claims.

The present specification discloses a hybrid battery-charging device. Input terminals are provided for connecting a photo-voltaic panel or other current source and output terminals are provided for connecting a load. Furthermore, first battery connections are provided for connecting a lead-acid battery and second battery connections are provided for connecting a high-cycle chemical battery, such as a rechargeable lithium-ion battery, wherein “lithium-ion” also includes lithium polymer batteries.

A two-way DC/DC converter is connected between the high-cycle chemical battery and the lead-acid battery such that a first set of terminals of the two-way DC/DC converter is connected with the second battery connections and a second set of terminals of the two-way DC/DC converter is connected with the first battery connections. This also comprises connecting the negative or the positive terminal to a ground potential.

An input to the output terminals is derived from the first battery connections in the sense that the output terminals are directly connected to the first battery connections or they are connected via further components.

A charge and discharge control system is provided which comprises, among others a first sensing input for sensing a state of charge of the lead-acid-battery, a second sensing input for sensing a state of charge of the high-cycle chemical battery and a control output for controlling the two-way DC/DC converter, and a controller unit, such as a microcontroller.

During operation, the two-way DC/DC converter is regulated or controlled over the control output in a feed-back loop which depends on the signals at the first and second sensing inputs as input signals. Specifically, the charge and discharge control system is operative to control the two-way DC/DC converter such that the charging of the lead-acid battery (12) is provided if its state of charge is below a pre-determined threshold. In one embodiment, the pre-determined threshold is at a low SoC, such as 30-40%, in another embodiment the pre-determined threshold is at a high SoC, such as 95%-105%, while in a further embodiment, the pre-determined threshold is at an intermediate SoC.

The two-way DC/DC converter is furthermore controlled such that the charging of high-cycle chemical battery is provided if the state of charge of the high-cycle chemical battery is below a pre-determined threshold and if the state of charge of the lead-acid battery is above a pre-determined threshold. In particular, the pre-determined threshold of the lead-acid battery may correspond to a threshold that is advantageous for the health of the lead-acid battery such as a state of charge of 30-40%.

In a further embodiment, the charge and discharge control system is operative to control the two-way DC/DC converter such that a discharging of the lead-acid battery is provided if the state of charge of high-cycle chemical battery is below a pre-determined threshold or if a power demand of the load exceeds a pre-determined power capability of the two-way DC/DC converter and of the high-cycle chemical battery. According to a further modification, the charge and discharge control system is operative to discharge the lead-acid battery only if, as a further condition, its state of charge is above a pre-determined state of charge which is beneficial for the health of the lead-acid battery, for example a SoC of 30-40%.

In a hybrid battery-charging device according to the specification, a joint discharging of the high-cycle chemical battery and the lead-acid battery for a high power demand of the load can be achieved by providing a two-way DC/DC converter and a high-cycle chemical battery with suitable specifications. It is not required to provide a feedback control for this purpose.

According to a more specific embodiment, the current specification discloses a hybrid battery-charging device with input terminals for connecting a photovoltaic panel or other current supply and output terminals for connecting a load.

Furthermore, first battery connections are provided for connecting a lead-acid battery and second battery connections are provided for connecting a high-cycle chemical battery. A high-cycle chemical battery is provided and terminals of the high cycle chemical battery are connected to the second battery connections.

An input to the output terminals is derived from the first battery connections in the sense that the output terminals are directly connected to the first battery connections or they are connected via further components.

A two-way DC/DC converter is connected between the second battery connections and the first battery connections such that a first set of terminals of the two-way DC/DC converter is connected with the second battery connections and a second set of terminals of the two-way DC/DC converter is connected with the first battery connections. A one-way DC/DC converter is connected between the input terminals and the first battery connections.

Furthermore, a controllable switch is connected between the first battery connections and the output terminals. During charging, the two-way DC/DC converter and the one-way DC/DC converter are controlled base on the state of charge of the lead-acid battery and of the high-cycle chemical battery. During discharging, the two-way DC/DC converter is controlled in dependence of the state of charge of the lead-acid battery and of the state of charge of the high-cycle chemical battery.

According to one embodiment, the high-cycle chemical battery comprises a rechargeable lithium-ion battery. According to a further embodiment, the hybrid storage system comprises a charge and discharge control system with a first sensing input for sensing a state of charge of the lead-acid-battery, a second sensing input for sensing a state of charge of the high-cycle chemical battery, a first control output that is connected to the two-way DC/DC converter and a second control output that is connected to the one-way DC/DC converter.

According to one embodiment, one or more of the sensing inputs is connected to sensors at the batteries, whereas in another embodiment, one or more of the sensing inputs is connected to a sensing chip which is connected to one or more sensor and which comprises an A/D converter. In particular, a sensor may also comprise electronic components that are used in the function of a sensor, such as an external coil or a resonance circuit.

A controller unit, such as microcontroller, is connected to the first sensing input, to the second sensing input, to the first control output and to the second control output.

In a further embodiment, the hybrid battery-charging device comprises a voltage monitoring chip that is connected between the high-cycle chemical battery and the second sensing input (74). The voltage monitoring chip may be attached to the high-cycle chemical battery such that it can be sold and exchanged together with the high cycle chemical battery or it may be attached to a casing of the hybrid battery-charging device.

According to a further embodiment, the charge and discharge control system is operative to close a switch of the two-way DC/DC converter during the second discharge phase and during the first charge phase such that the second battery connections are electrically disconnected from the first battery connections. Thereby, essentially no charge or discharge current flows to or from the high-cycle battery, except for small residual currents such as thermal currents, quantum noise or small parasitic currents.

According to a further embodiment, the charge and discharge control system is operative to discharge the high-cycle chemical battery to a predetermined lower state of charge and to discharge the lead-acid battery to a pre-determined discharged state of charge after the high-cycle chemical battery has reached the predetermined lower state of charge. In particular, the pre-determined lower SoC of the high-cycle chemical battery may correspond to a very low SoC that is required for battery health and the pre-determined SoC of the lead-acid battery may correspond to a SoC that is advantageous to reduce aging processes, such as a SoC of 30-40%.

According to yet a further embodiment, the hybrid battery charging device is operative to charge the lead-acid battery to a first pre-determined upper state of charge, which may be a high Soc such as 100%+/−5%, and to charge the high-cycle chemical battery to a second predetermined upper state of charge after the lead-acid battery has reached the first predetermined upper state of charge. The second pre-determined upper state of charge may also be a high SoC, such as 95%+/−5% or it may be lower if there is a requirement to end the charge cycle of the high-cycle chemical battery before the high-cycle chemical battery is fully charged.

According to a further aspect, the present specification discloses a method for discharging a hybrid storage system which comprises a lead-acid battery and a high-cycle chemical battery that are in parallel, and wherein a two-way DC/DC converter is connected between terminals of the lead-acid battery and terminals of the high-cycle chemical battery.

An output voltage of the two-way DC/DC converter is provided such that a voltage at the terminals of the lead-acid battery is equal to or greater than a battery voltage of the lead-acid battery as long as a pre-determined power rating of the two-way DC/DC converter and the high chemical battery is not exceeded. Thereby a discharge of the lead-acid battery is prevented.

When it is detected that the high-cycle chemical battery has reached a pre-determined lower state of charge, the two-way DC/DC converter is controlled such that the high-cycle chemical battery is disconnected from the lead-acid battery, for example by keeping a switch of the two-way DC/DC converter open. Thereby, further discharge of the high-cycle chemical battery is prevented and discharge of the lead-acid battery is allowed for.

According to a further aspect, the present specification discloses a method for charging a hybrid storage system with a lead-acid battery and a high-cycle chemical battery that are connected in parallel, and wherein a two-way DC/DC converter is connected between terminals of the lead-acid battery and terminals of the high-cycle chemical battery.

The two-way DC/DC converter is controlled such that an output voltage of the two-way DC/DC converter is higher than an open circuit voltage or battery voltage of the lead-acid battery, thereby allowing charging of the lead-acid battery. Herein, input/output voltage is defined in relation to the charge/discharge current.

Furthermore, the two-way DC/DC converter such that the high-cycle chemical battery is disconnected from the lead-acid battery, thereby preventing charging of the high-cycle chemical battery.

According to a further embodiment, the charging method comprises computing a state of charge of the lead-acid battery using a controller unit. If it is detected that the lead-acid battery has reached an upper state of charge, the two-way DC/DC converter is controlled such that a state of charge of the lead-acid battery is essentially maintained and the two-way DC/DC converter is controlled such that an output voltage of the two-way DC/DC converter is higher than an open circuit voltage or battery voltage of the high-cycle chemical battery, thereby allowing charging of the high-cycle chemical battery.

To avoid gassing, the voltage at the lead-acid battery may be dropped temporarily such that the SoC falls below 100%. Depending on the specifications of the lead-acid battery, the lead acid-battery may also be slightly overcharged.

Furthermore, the present application provides a hybrid battery-charging device with input terminals for connecting a photovoltaic panel and first battery connections for connecting a lead-acid battery. A lead-acid battery according to the application comprises various types such as a liquid acid battery, a lead-gel battery or an absorbent glass mat (AGM) lead battery.

Furthermore, the battery-charging device comprises second battery connections for connecting a high cycle chemical battery. A lithium battery such as a lithium-ion battery or a lithium polymer battery may provide the high cycle chemical battery but other high cycle chemical batteries such as a Nickel-Iron battery may also be used.

Within the context of the present application a “chemical battery” refers to a battery in which a charging or discharging of the battery involves the movement of ions and chemical reactions at the respective anodes of the battery. This stands in contrast to capacitors such as plate capacitors, electrolytic capacitors or double layer capacitors, which are also known as super-capacitors, wherein charging or discharging merely involves the rearrangement of electrons or of other charged particles without a chemical reaction taking place. Furthermore, a high-cycle chemical battery according to the application is a rechargeable battery.

According to the application, the characteristics of a high-cycle chemical battery complement the characteristics of the lead-acid battery. The lead-acid battery is well adapted to being fully charged or even slightly overcharged while the high-cycle chemical battery is well adapted to a deeper discharge level. Lead-acid-batteries are relatively inexpensive and are often used for remote energy systems. Such a lead-acid battery can even be provided by a simple car battery but it is more advantageous to use specially adapted batteries which tolerate deeper discharges.

The battery-charging device comprises a two-way DC/DC converter, which is also known as bidirectional DC/DC converter. The two-way DC/DC converter is used to charge the lithium battery in a first current direction as well as to discharge the lithium battery in a second current direction.

A first set of terminals of the two-way DC/DC converter is connected with the second battery connections and a second set of terminals of the two-way DC/DC converter is connected with the first battery connections. An input to the second set of terminals is derived from the input terminals of the hybrid battery-charging device. Herein, an input of B being “derived” from A means that B receives an input from A, wherein the input may be transmitted from A to B directly via an electric line or indirectly via other components such as switches, transistors etc.

Furthermore, a charge and discharge control system is provided, which is connected to the two-way DC/DC converter via respective control lines and output terminals for connecting a load. An input of the output terminals is derived from the first battery connections via a connecting arrangement for connecting the output terminals to the first battery connections, such as a magnetic switch or a semiconductor switch.

In the direct current circuits of the hybrid battery-charging device, either one of the poles may be connected to a common ground in a known way. For example, a minus pole connection of the first battery connections and a minus pole terminal of the output terminals may be connected to a common ground potential. In other words, one of the respective battery connections and one of the output terminals may be provided by respective connections to the common ground potential. The input terminals of the two-way DC/DC converter are also referred to as “system terminals” and the voltage across the system terminals is also referred to as “system voltage”.

Furthermore, the hybrid battery-charging device may comprise a control device such as a controlled on/off switch, a pulse width modulation (PWM), a maximum power point tracker, etc. for better controlling the charge voltage of the batteries. The control device is connected between the input terminal of the system and input terminals of the DC/DC converter, which are in turn connected to terminals of the lead-acid battery. Furthermore, the control device is connected to the charge and discharge control system via control lines. For example, the control lines may be configured for switching transistors of a PWM in the control device.

The two-way DC/DC converter may comprise, for example, a buck-boost converter, a buck converter or a boost converter for providing a suitable voltage ratio for charging or discharging the lithium battery. Especially, the two-way DC/DC converter may comprise a step-up converter for providing a higher voltage to the lithium battery than the end-of-charge voltage of the lead-acid battery.

In particular, the two-way DC/DC converter may comprise at least two semiconductor switches, wherein respective input connections of the transistors are connected to the charge control system via respective control lines. In this way, the two-way DC/DC converter is easy to control via electric signals. In particular, the transistors may be realized as power transistors.

Furthermore, the hybrid battery-charging device may comprise first and second voltage measuring connections for connecting first and second voltage sensors. The first voltage sensor is connected to terminals of the lead-acid battery and the first voltage measuring connections are connected to the charge and discharge control system. The second voltage sensor is connected to terminals of the lithium battery and the second voltage measuring connections are connected to the charge and discharge control system, wherein the connection may be direct or also indirect via a separate controller for managing the state of charge of the lithium battery such as a voltage monitoring chip. The voltage monitoring chip may be connected to the voltage sensor of the lithium battery and to the charge control system via a control line.

In particular, the lithium battery, the two-way DC/DC converter and the voltage monitoring chip for the lithium battery may be mounted together in an energy storage subsystem, wherein the energy storage subsystem provides input terminals for plugging the energy storage subsystem into the hybrid battery-charging device. Thereby, the building block comprising the lithium battery can be used and serviced separately from the rest of the hybrid battery-charging device.

The first and second voltage sensors may be provided as component of the hybrid battery-charging device, for example within the charge and discharge control system or they may be provided as components of the respective batteries.

The hybrid battery-charging device may furthermore comprise a separate battery management system for the lithium battery, the separate battery management system that is connected to the charge and discharge control system. In this way, an existing battery-charging device, for example a battery-charging device for a lithium battery, or parts of it may be used in the hybrid battery-charging device according to the application.

The application furthermore discloses a hybrid storage system with a hybrid charging device according to the application that further comprises lithium battery which is connected to the second battery connections.

Furthermore, the hybrid storage system may further comprise a capacitor such as an ultracapacitor, which is connected in parallel to the lithium battery, for a fast response to high load peaks of a connected load.

Furthermore, the application discloses a hybrid storage system with a hybrid charging device according to the application that further comprises a lead-acid battery that is connected to the first battery connections.

The hybrid storage system may comprise furthermore a first voltage sensor, which is connected to a terminal or to terminals of the first battery and to the charge and discharge control system, and a second voltage sensor, which is connected to a terminal or to terminals of the second voltage battery and to the charge and discharge control system.

Furthermore, the application discloses a method for charging a lead-acid battery and a lithium battery of a hybrid storage system by an electric power source such as a photovoltaic panel.

According to the application, a lead-acid battery is charged in a first battery charging phase until the lead-acid battery has reached a first pre-determined state of charge. During the first battery charging phase, in which the lead-acid battery is charged, the charging may be controlled just by limiting to a maximum current or to perform unlimited charging or bulk charging, for example by a PID controller which uses the charging voltage and current as input data.

In an equalization phase, which is also known as a topping or boost phase, the lead-acid battery and the lithium battery are both charged until the lead-acid battery has reached a second pre-determined state of charge. In addition, the lead-acid battery and the lithium battery may also be charged during an “absorption phase” or a boost phase of the lead-acid battery. In the equalization and absorption phases, the system voltage is kept constant at different setpoints, which correspond to the phases.

During the equalization phase, an applied voltage at the lead-acid battery can be made to oscillate between a pre-determined lower voltage and a pre-determined upper voltage. In particular, the voltage may be applied by pulse charging, and especially by pulse-width modulated charging. The voltage of the charge pulses may be higher than the end of charge voltage of the lead-acid battery. The charge pulse can contribute to a higher charge and life expectancy of the lead-acid battery by equalizing the charges on the battery cells, mixing the electrolyte and reducing the sulfation. Furthermore, a mean voltage at terminals of the lead-acid battery is close to an end-of-charge voltage of the lead-acid battery during the equalization phase. During the equalization phase, the charge current to the lead-acid battery will decrease because the charge state of the lead-acid battery approaches 100%.

The lithium battery is charged in a third battery charging phase during which an essentially constant system voltage is applied to system terminals of the lead-acid battery and the first voltage is converted into a charging voltage at terminals of the lithium battery.

Advantageously, the essentially constant system voltage that is applied to the system terminals during the charging of the lithium battery in the third battery charging phase is made equal to a maximum open circuit voltage of the lead-acid battery. Thereby, the lead-acid battery will not discharge significantly, even if it remains connected to the lithium battery. On the other hand, an overcharging of the lead-acid battery is avoided by keeping the terminals of the lead-acid battery at its maximum open circuit voltage. In addition, a trickle or standby charge may be applied to the lead-acid battery during which the applied voltage may be higher than the maximum open circuit voltage of the lead-acid battery.

Furthermore, the application discloses a method for discharging a lead-acid battery and a lithium battery of a hybrid storage system. According to the application, a load is supplied with power by discharging the lithium battery via system terminals of the lead-acid battery. During discharging of the lithium battery, the voltage at the system terminals is maintained essentially equal to a maximum open circuit voltage of the lead-acid battery until a voltage at terminals of the lithium battery has reached an end-of-discharge voltage of the lithium battery.

Thereby, it is not required to provide a direct connection between the lithium battery and the load. This ensures that the lead-acid battery is not already discharged, even if it is not disconnected. A controlled DC/DC converter can provide the required voltage, for example.

If the output voltage of the lithium battery has reached an end-of-discharge voltage of the lithium battery, the lead-acid battery is discharged until the voltage of the lead-acid battery has reached an end-of-discharge voltage of the lead-acid battery. The end-of-discharge voltage of the lead-acid battery is a voltage to which the lead-acid battery can be discharged safely. The end-of-discharge voltage of the lead-acid battery corresponds to a SOC of about 30-40% of the lead-acid battery.

Similarly, if a load draws current from the lithium battery such that a voltage at terminals of the lead-acid battery drops below a maximum open circuit voltage of the lead-acid battery, the lead-acid battery is discharged in parallel with the lithium battery until the lithium battery has reached an end-of-discharge voltage.

In addition, the lead-acid battery may be disconnected after discharging the lead-acid battery and/or the hybrid storage system may enter a standby mode until it is determined that an electric power source can supply enough power to load the first battery. The disconnection of the lead-acid battery may be achieved by an on/off switch for disconnecting the load and/or achieved by a separate on/off switch, which is provided at the lead-acid battery. In particular, the standby mode may provide a reduced power consumption by suspending measurements of a system voltage at terminals of the first battery and of a voltage at terminals of the second battery.

Furthermore, the application discloses a hybrid battery-charging device according to the application wherein the charge and discharge control system is operative for executing a charge or a discharge method according to the application. This may be realized for example by providing a computer readable program of a programmable microcontroller or a special purpose circuit, which is provided in the charge and discharge control device of the hybrid battery-charging device.

In general, a hybrid storage system according to the application may be used wherever there is a need for an efficient intermediate storage of energy from an energy source. This applies in particular to energy systems in which a supply from an energy source and/or an energy demand of an energy consumer varies over time. More specifically, these conditions apply for off-grid applications, which are supplied by a varying energy source such as solar energy or wind energy. An off-grid solar power station with a hybrid storage system according to the application may be used, for example, in remote geographical locations such as the interior of Africa or Brazil. Furthermore, it can also be used for powering installations that are typically located outside of agglomerations such as communication antennas, weather stations, fire observation towers, emergency shelters, devices in outer space etc.

According to the present specification a maximum power rating of the two-way DC/DC converter between the lead-acid and the lithium-ion battery and a maximum power rating of the lithium ion battery depend on a pre-determined maximum load demand.

A hybrid storage system according to the present specification can provide low charging and discharging currents. A cheaper two-way DC/DC converter that is configured for low power can be used. The hybrid storage system can be provided without a dedicated heat management system when there is no significant self-heating in the relevant current range, although a heat management system may be provided if needed.

In a hybrid storage system according to the present specification an operating current of the lithium battery can be limited. This in turn slows down the degradation speed of the lithium battery and the efficiency of the lithium battery increases due to reduced energy losses by heat dissipation.

The hybrid storage system according to the present specification can be configured such that a power demand is met even when the hybrid storage system is provided with a low cost two-way DC/DC converter and lithium battery pack, wherein the two-way DC/DC converter has a reduced power rating and the current rating of the lithium battery is limited. During peak power demand, the lead-acid battery stabilizes the interlink between the DC/DC converter connected to the power supply and the two-way DC/DC converter connected to the lithium battery. The hybrid storage system can still supply the load, even if the two-way DC/DC converter or the lithium battery fails.

In a hybrid control strategy according to the present specification consisting of lead-acid and lithium-ion batteries, the batteries are cycled in sequence. The lithium-ion battery is discharged first followed by the lead-acid battery. During charging, the lead-acid battery is charged first followed by lithium-ion battery.

The electrical energy to charge or discharge the Li-ion battery is converted in an integrated DC/DC converter, also referred to as “DC/DC2”. According to a basic concept of the hybrid storage system, the maximum power rating of the DC/DC converter as well as the maximum current rating of the Li-ion battery depend on the maximum load demand such that a load demand is met during operation.

According to the present specification it can be advantageous to limit the current rating of the converter and of the batteries for several reasons, such as:

1) Cost of power electronics: A cheaper DC/DC2 Converter configured for low power can be used. Additionally, a heat management system for the battery pack might not be required as no significant self-heating is expected in the low current range.

2) Lifetime of Li-battery: The lithium-ion battery pack may age rapidly when operated at high current densities. Reduced self-heating by limiting the operating current slows down the degradation speed and therefore results in a higher cycle life performance. Moreover, the efficiency of the Li-battery increases as a result of reduced energy loss through heat dissipation.

3) Cost of the battery management System (BMS): As a result of low charging and discharging currents, a low cost BMS configured for low power can be used. By design of the circuit, the load can always be met, even after reducing the DC/DC2 power rating and limiting the battery current rating. During peak power demand the lead-acid battery stabilizes the interlink between both DC/DC converters and the load.

The two-way DC/DC converter and the lithium-battery pack can be made cost-effective while still being able to supply the load. The lead-acid battery can easily supply much higher currents without aging rapidly.

In addition, a hybrid storage system according to the present specification can be made fail-safe due to its design concept. Even if the two-way DC/DC converter fails, the system can still supply the load.

The application will now be explained in further detail with respect to the following Figures.

### BRIEF DESCRIPTION OF THE FIGURES

FIG. 1 shows a general layout of a hybrid storage system according to the application.

FIG. 2 shows a detailed view of the layout of FIG. 1.

FIG. 3 shows a circuit diagram of the hybrid storage system according to FIGS. 1 and 2.

FIG. 4 shows state of charge curves for a 12-volt lead-acid battery of the storage system of FIG. 1 under different conditions.

FIG. 5 shows a system voltage, a state of charge of a lead-acid battery and a state of charge of a lithium battery of the hybrid storage system of FIG. 1 during typical charging and discharging processes.

FIG. 6 shows the further parameters of the hybrid storage system of FIG. 1 for a discharge process for a high load.

FIG. 7 shows a flow diagram of a charging and a discharging process of the storage system of FIG. 1.

FIG. 8 shows another hybrid storage system with a first hybrid battery-charging device.

FIG. 9 shows a further hybrid storage system with a second hybrid battery-charging device according to the application.

FIG. 10 shows a discharge cycle of the hybrid storage system of FIG. 1.

FIG. 11 shows a charge cycle of the hybrid storage system of FIG. 1.

FIG. 12 shows a further view of the hybrid storage system of FIG. 1.

### DETAILED DESCRIPTION

In the following description, details are provided to describe embodiments of the application. It shall be apparent to one skilled in the art, however, that the embodiments may be practiced without such details.

Some parts of the embodiments are similar. The similar parts may have the same names or similar part numbers. The description of one part also applies by reference to another similar part, where appropriate, thereby reducing repetition of text without limiting the disclosure.

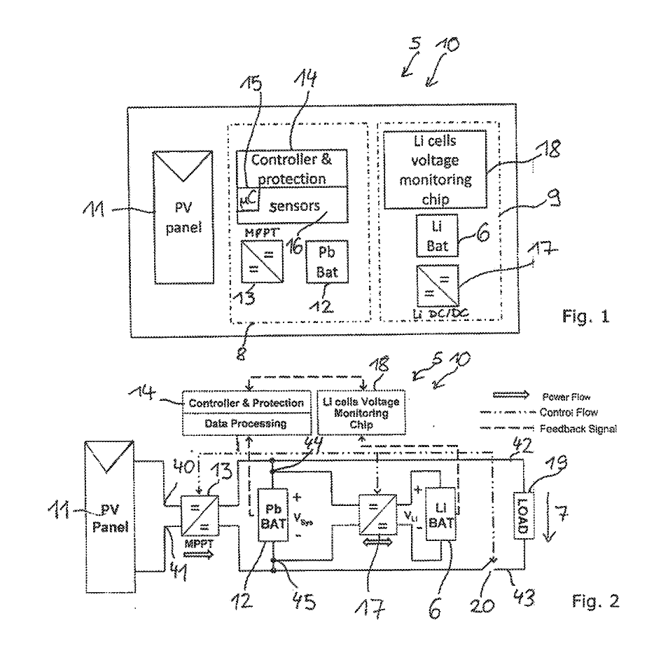

FIG. 1 shows a layout of a hybrid storage system 5 with a hybrid battery-charging device 10. According to the application, the hybrid storage system 5 comprises at least one battery while a hybrid battery-charging device does not necessarily include the batteries.

The hybrid storage system 5 comprises a first energy storage subsystem 8 with a photovoltaic panel 11 and a second energy storage subsystem 9. The first energy storage subsystem 8 comprises a lead-acid battery 12, a unidirectional DC/DC converter 13 and a charge control system 14. The charge control system 14 comprises a microcontroller 15 and sensors 16. The sensors 16 comprise a voltage sensor at the terminals of the lead-acid battery 12. The DC/DC converter 13 is connected to a maximum power point tracker (MPPT). The maximum power point tracker provides an impedance matching for the photovoltaic panel 11 and it may be realized by a portion of the charge control system 14 and further hardware components.

Typically, the MPPT uses a measurement of the voltage across the photovoltaic panel 11, a measurement of an electrical current from the photovoltaic panel 11 and, optionally, further measurements to generate a control signals corresponding to a reference voltage and/or to a reference current. MPPT algorithms comprise constant voltage, perturb and observe and incremental conductance algorithms.

Especially for remote energy systems with higher output powers (e.g. above 300 Watt) it is advantageous to use a maximum power point tracker (MPPT) in a system according to the application. Thereby, it is possible to achieve high efficiencies. However, a system according to the application can also be operated as with an off-grid solar systems without an MPPT or input-DC/DC converter 13.

The second energy storage subsystem 9 comprises a lithium battery 6, a bidirectional DC/DC converter 17 and a voltage monitoring chip 18. The DC/DC Converters 13 and 17 may be implemented in various ways, for example as buck converters, as boost converters or as buck-boost converters.

FIG. 2 shows a detailed view of the layout of FIG. 1. According to the layout of FIG. 2, the lithium battery 6 is connected in parallel to the lead-acid battery 12 and to a load 19 via the bidirectional DC/DC converter 17. Furthermore, output lines of the DC/DC converter are connected in parallel to the lead-acid battery 12. A load switch 20 is connected in series to the load 19. The load switch 20 is provided to prevent a deep discharge and it may be implemented as a semiconductor switch such as a bipolar transistor, a FET, an IGBT, or others. An arrow 7 indicates a direction of current.

Dashed arrows in FIG. 2 indicate the flow of sensor signals to the charge control system 14 and to the voltage monitoring chip 18 while dash-double-dot arrows indicate the flow of signals between the charge control system 14 and the voltage monitoring chip and the flow of control signals from the charge control system 14.

The hybrid storage system provides a positive input terminal 40 and a negative input terminal 41, which are connected to corresponding output terminals of the photovoltaic panel (or other energy sources) 11, and a positive output terminal 42 and a negative output terminal 43, which are connected to corresponding input terminals of the load 19. The lithium subsystem 9 comprises a positive input terminal 44 and a negative input terminal 45, which are connected to respective terminals of the lead-acid battery 12. Furthermore, the lithium subsystem 9 comprises a positive output terminal 46 and a negative output terminal 47 which are connected to respective terminals of the lithium battery 6.

For a load 19 that comprises an AC consumer, a DC/AC converter may be connected between the output terminals 42 and 43 and the load 19. A DC/AC converter may be provided, for example by a switched H-bridge or a switched three-phase inverter.

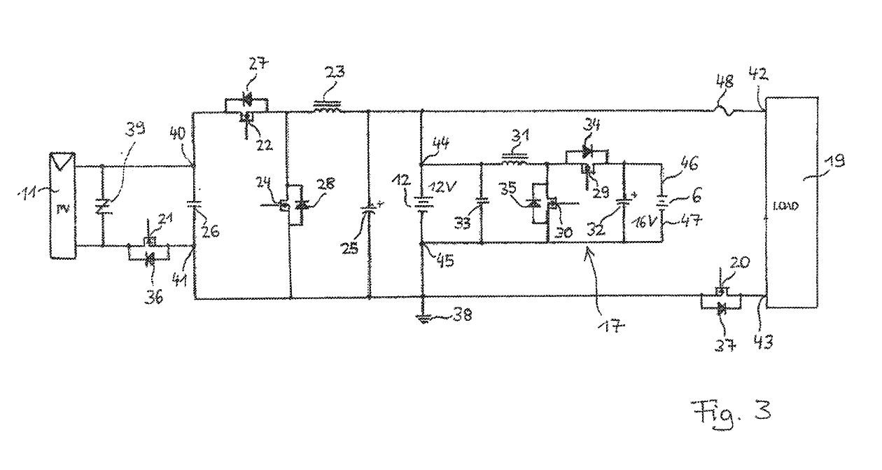

FIG. 3 shows a circuit diagram of the hybrid storage system 5 according to FIG. 2. In the example of FIG. 3, the lead-acid battery 12 can deliver a voltage of around 12 V and the lithium battery 6 can deliver a voltage of around 24 V. The photovoltaic panel 11 is connected to the hybrid storage system 5 via a reverse current protection MOSFET 21 (may also be a diode). A TVS-diode 39 for transient voltage suppression (TVS) and overvoltage suppression is connected in parallel to the photovoltaic panel 11.

The DC/DC Converter 13, which is connected to outputs of the photovoltaic panel 11 and to battery terminals of the lead-acid battery 12, comprises a first MOSFET 22, a second MOSFET 24 and inductor 23, which are connected in star connection. A first terminal of a capacitor 25 is connected to a plus pole battery terminal of the lead-acid battery 12 and a second terminal of the capacitor 25 is connected to a minus pole battery terminal of the lead-acid battery 12.

Furthermore, a second capacitor 26 is connected in parallel to the input terminals 40 and 41 and works as an input filter. The first MOSFET 22 comprises a parasitic diode 27 and the second MOSFET comprises a parasitic diode 28.

During operation, the output power of the photovoltaic panel 11 or of the DC/DC converter 13 is measured by the charge control system 14. A control signal of the charge control system 14 adjusts the ratio of the DC/DC converter 13 via opening and closing of the MOSFETS 22 and 24 according to a maximum power point of the photovoltaic panel 11.

The DC/DC converter 17, which is connected to battery terminals of the lithium battery 6 and to battery terminals of the lead-acid battery 12, comprises a first MOSFET 29, a second MOSFET 30 and inductor 31 which are connected in star connection. A plus pole battery terminal of the lithium battery 6 is connected to a first terminal of a capacitor 32 and a minus pole battery terminal of the lithium battery 6 is connected to a second terminal of the capacitor 32.

The capacitors 25, 26, 32 and 33, on the other hand, act as filters for smoothing out the output voltage.

The first MOSFET 29 comprises a parasitic diode 34 and the second MOSFET 30 comprises a parasitic diode 35. The protection MOSFET 21 comprises a parasitic diode 36 and the load switch 20 comprises a parasitic diode 37. The parasitic diodes 21, 28, 34, 35, 36 and 37 also act as freewheel diodes with respect to the corresponding MOSFETS 22, 24, 29, 30, 21 and 20. Instead of MOSFETS, other field effect transistors may be used as well, like for example IGBTs, JFETs or others.

A fuse 38 is provided close to a positive output terminal of the hybrid storage system 5 to protect the circuitry of the hybrid storage system 5 from overload. A ground potential 38 is connected to the minus pole terminal of the lead-acid battery 12, to the minus pole terminal of the lithium battery 6 and to respective terminals of the capacitor 25, the second MOSFET 24 and the second capacitor 26 of the DC/DC converter 13.

According to the application, separate switches at the batteries 6, 12 are not required. The lead-acid battery 12 and the lithium battery 6 may be equipped with switches, respectively, for connecting and disconnecting the lead-acid battery 12 and the lithium battery 6, however.

The DC/DC converter 13 is controlled through control signals at the respective gate electrodes of the MOSFETS 24 and 22 and the DC/DC converter 17 is controlled through control signals at the respective gate electrodes of the MOSFETS 29 and 30. The DC/DC converters 13 and 17 can be operated as charge pulse generators by applying pulse width modulated pulses at the respective bases or gates of the respective transistors.

In a charge mode, the charge pulses can be used for charging the batteries lead-acid battery 12 and the lithium battery 6 and, in a recovery mode, they can be used for desulfurization of the lead-acid battery 12. With respect to charging, the term “pulse-width modulation” (PWM) refers to applied signals at semiconductor switches. The generated charge or voltage pulses will in general not take the shape of rectangular pulses. This is different from the output of a switched H-bridge for driving a motor via PWM, for example.

During operation, a voltage of the lithium battery 6 is measured by the voltage monitoring chip 18 and a voltage of the lead-acid battery 12 is measured by the charge control system 14. The charge control system 14 adjusts the current of the DC/DC converter 13 via control signals to the MOSFETS 22 and 24. Similarly, the charge control system 14 adjusts the current or power through the DC/DC converter 17 via control signals to the MOSFETS 29 and 30. By increasing the input voltage through the DC/DC converters 13 and 17, the photovoltaic panel can be used for charging the batteries 12 and 6 even in periods of weaker insolation.

Furthermore, the charge control system 14 controls the opening and closing of the protection MOSFET 21 and of the load switch 20 by respective control signals.

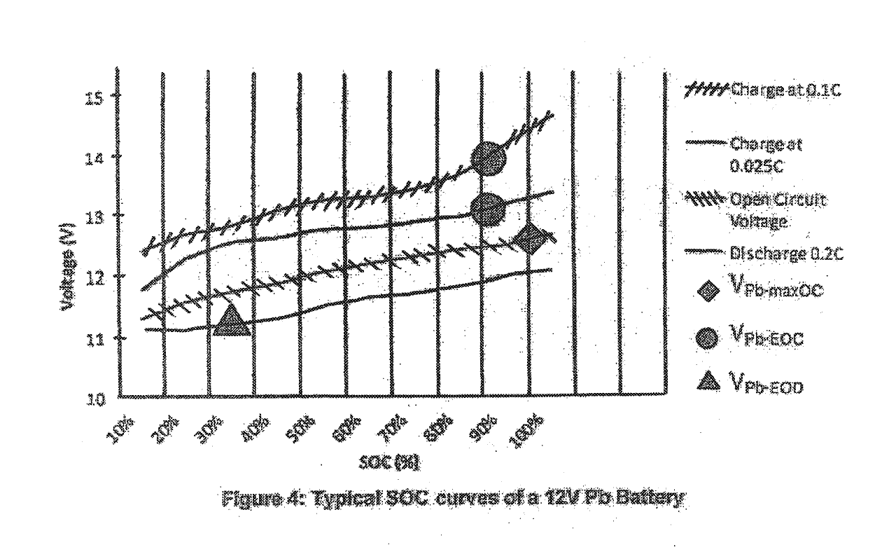

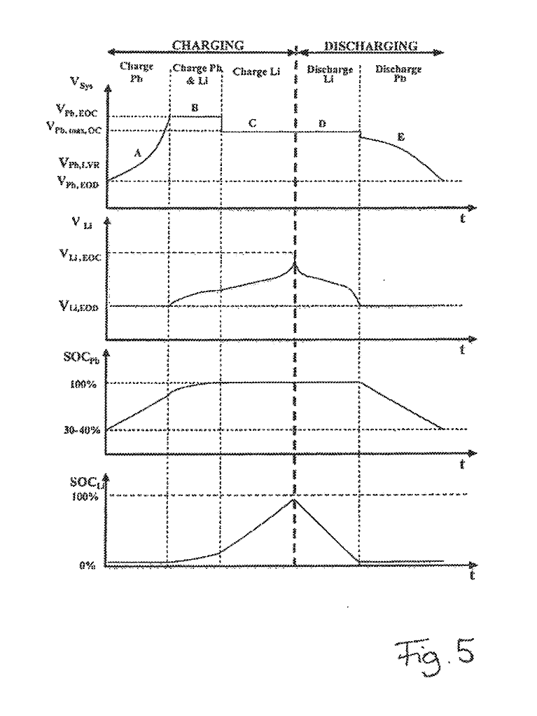

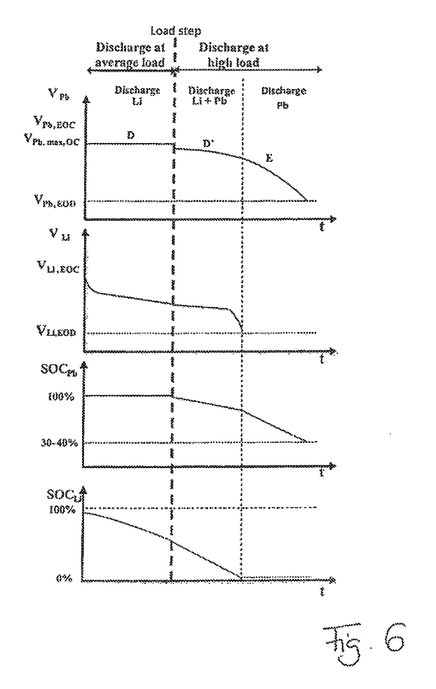

The generation of the control signals of the charge control system 12 according to the application is now explained in more detail with respect to the following FIGS. 4 and 5.

FIG. 4 shows state of charge curves for a 12 V lead-acid battery under different conditions. The topmost curve shows an external voltage that is required for charging the lead-acid battery at a charge rate of 0.1 C. This charge rate signifies a capacity of a battery in ten hours. At a charge rate of 0.1 C, the lead-acid battery reaches an end-of-charge voltage V_EOC of about 13.5V at a state of charge (SOC) of about 90%, which is indicated by a circle symbol. The second curve from the top shows an external voltage that is required for charging the lead-acid battery at a charge rate of 0.025 C. In this case, the lead-acid battery reaches an end-of-charge voltage V_EOC of about 13V at a state of charge of about 90%, which is indicated by a circle symbol.

The second curve from below shows open circuit voltages for different charge states of the lead-acid battery. A maximum open circuit voltage V_maxOC of about 12.5 Volt is marked by a diamond symbol. The lowest curve shows a voltage that is delivered by the lead-acid battery when a load is chosen such that the lead-acid battery is discharged at a discharge rate of about 0.2 C. At a charge state of about 35% battery charge, an end of discharge voltage is reached. The voltage V_EOD between the battery terminals of the lead-acid battery at the end of discharge, which is at about 11.2 Volt, is marked by a triangle symbol.

In general, the following voltages are used in the control algorithms according to the application.
V_Sys, which corresponds to the voltage of the lead-acid battery 12 and to the voltage at the second set of terminals of the DC/DC converter 17. According to the application, a decision on which battery is charged or discharged depends on V_sys and, as an option, on the current.
V_EOC, which denotes an end-of-charge voltage. In lithium batteries, this voltage (V_Li_EOC) can correspond to a SOC of about 100%. By contrast, the end-of-charge voltage in lead (Pb) batteries (V_Pb_EOC) corresponds to a SOC of 85-90%. In order to reach an SOC of 100%, the lead-acid battery has to be charged further after the end-of-charge voltage has been reached. As shown in FIG. 4, the voltage V_Pb_EOC can depend on the charge rate. Furthermore, it also depends on characteristics of the lead-acid battery such as age and operating temperature.
V_EOD, which denotes an end-of-discharge voltage. In lithium batteries, this voltage (V_Li_EOD) corresponds to a certain low level of SOC, whereas in lead batteries, in order to avoid damage to the battery, this voltage (V_Pb_EOD) will correspond to a SOC of e.g. 30-35%, as shown in FIG. 4. The voltage V_Pb_EOD depends also on the discharge current, age of the battery and battery temperature. It does not correspond to a predetermined fixed value in the control storage algorithm.

In a charging method according to the application, a pulse width modulation (PWM) charging mode is used to charge the lead-acid battery 12. The PWM charging mode provides an efficient charging mode for lead-acid batteries. A surplus energy, which is not needed for the PWM charging of the lead-acid battery 12, is automatically transferred to the lithium battery 6 of the lithium Subsystem 9. Thereby, a surplus of electric energy from the photovoltaic cells 11 is used to charge the lithium battery 6.

In a discharging method according to the application, the lithium subsystem is controlled to maintain a system voltage V_sys at a threshold voltage that corresponds to a voltage of the fully charged lead-acid battery 12. The System voltage V_sys is indicated in FIG. 2 by an arrow and it is measured between the connection lines to the lead-acid battery 12, which are connected to terminals of the lithium subsystem 9.

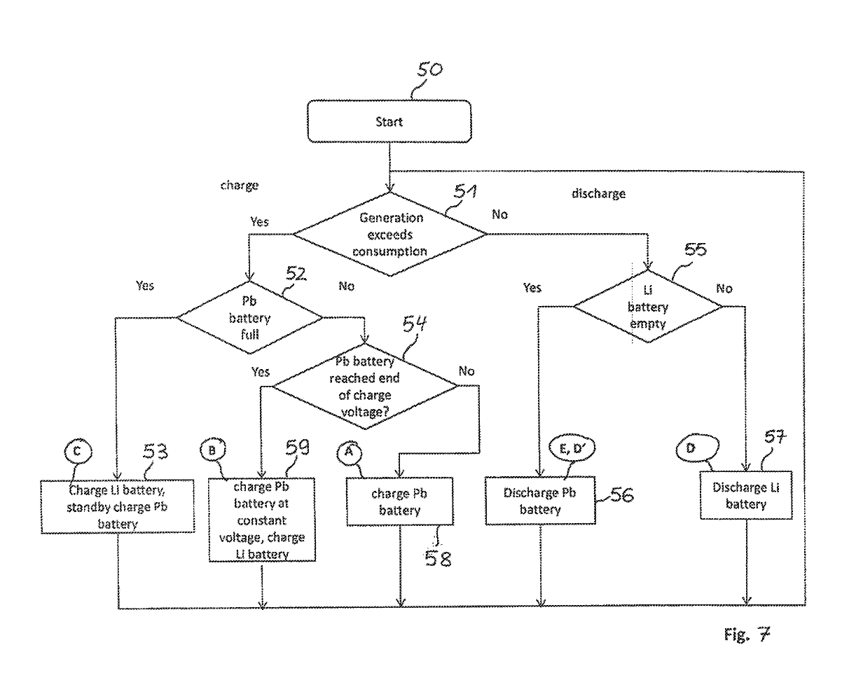

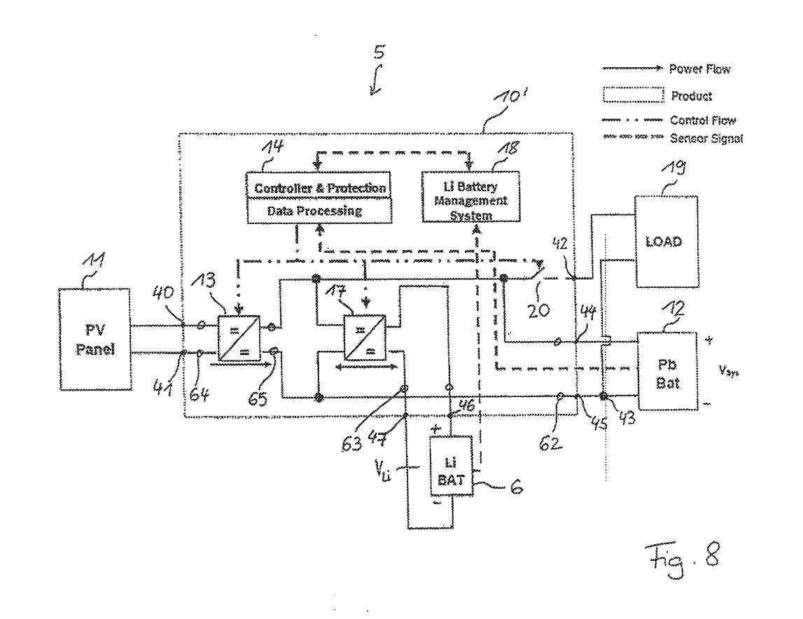

FIG. 5 shows voltage and state of charge diagrams for the lead-acid battery and for the lithium battery during a charging process according to the application. In FIGS. 5 and 6, system states, which are determined by the charge states of the two batteries is labelled by letters A to E. The letters correspond to labels in the flow diagram of FIG. 7. The letters A-E furthermore denote charge and discharge phases. As shown in FIG. 6, there is an additional discharge phase D-D′ when the load draws more power than the lithium battery 6 can deliver. In this case the lead-acid battery, which is also connected to the load will discharge simultaneously as the system voltage falls below the end of charge voltage of the lead-acid battery 12.

During the charging and the discharging process the charge control system 14 estimates the states of charge SOC_Pb and SOC_Li of the batteries 6, 12 based on the time dependence of the system voltage and/or on the current supplied to the batteries 6, 12.

In a first charging phase A, only the lead-acid battery 12 is charged. In the example of FIG. 5, a voltage at the lead-acid battery 12 is at an end-of-discharge voltage V_Pb_EOD and a voltage at the lithium battery 6 is at an end-of-discharge voltage V_Li_EOD.

During the first charging phase, the state of charge of the lead-acid battery 12 increases. The system voltage V_sys at terminals of the lead-acid battery 12 is measured in regular time intervals. As soon as the system voltage V_sys reaches the end-of-charge voltage V_Pb_EOC of the lead-acid battery 12, a second charging phase starts. In the second charging phase B, the lead-acid battery and the lithium battery are both charged. As soon as the state of charge SOC_Pb of the lead-acid battery 12 reaches approximately 100%, a third charging phase C is started, in which the lithium battery 6 is charged with a current and the lead-acid battery 12 is kept at the same SOC with a trickle charge. This can be seen in the state of charge diagrams, which show an increase of the lithium battery's state of charge and a constant state of the charge for the lead-acid battery.

FIG. 5 also shows a discharging process according to the application for a situation in which both batteries 6, 12 are fully charged at the beginning of the discharging process. In a first discharging phase D, only the lithium battery 6 is discharged. In the example of FIG. 5, the discharge current from the lithium battery 6 is approximately constant. As soon as the state of charge of the lithium battery 6 reaches a lower bound, only the lead-acid battery is discharged in a second discharge phase E.

In the example of FIG. 5, the time when the lower bound of SOC_Li is reached, is determined by the moment in which the voltage at the lithium battery drops to an end-of-charge voltage V_Li_EOC. The charge control system 14 disconnects the lead-acid battery 12 from the load by opening the load switch 12 when the system. voltage V_sys reaches an end-of-discharge voltage V_Pb_EOD.

FIG. 6 shows a second discharging process, wherein, in a discharge phase D′, the load draws more current than the lithium battery is able to deliver. In this case, the system voltage V_sys at the terminals of the lead-acid battery 12 drops below the maximum open circuit voltage V_PB_max_OC of the lead-acid battery, as shown in the topmost diagram of FIG. 6, and the lead-acid battery 12 is discharged together with the lithium battery 6. The discharge phases D′ and E are similar to those described with reference to FIG. 5.

FIG. 7 shows a flow diagram of the discharging and the charging process which indicates the operation principle of the charge control System 14.

In a step 50, a charge/discharge control is activated, for example by plugging in the lead-acid battery 12 and the lithium battery 6. This may involve additional steps, such as checking the health of the batteries and the correct connection of the batteries. In a decision step 51, it is decided whether enough power is available to charge the batteries. In a decision step 52, it is decided if the lead-acid battery 12 is fully charged, for example by measuring the system voltage V_sys. If the lead-acid battery 12 is determined as fully charged, the lithium battery 6 is charged and the lead-acid battery 12 is provided with a trickle charge in a step 53. If it is determined in step 52 that the lead-acid battery 12 is not yet fully charged, it is decided, in a decision step 54, if the lead-acid battery 12 has reached an end-of-charge voltage.

If the lead-acid battery 12 has not yet reached the end-of-charge voltage, it is charged in a step 58. If, on the other hand, it is determined that the lead-acid battery has reached the end-of-charge voltage, the lead-acid battery 12 is charged at a constant voltage while the lithium battery 6 is charged simultaneously.

If, in the decision step 51, it is determined that the generation does not exceed the consumption and the consumption is greater zero, than it is determined, in a decision step 55, if the lithium battery 6 is empty, wherein “empty” corresponds to a low SOC. If it is determined that the lithium battery 6 is empty, the lead-acid battery 12 is discharged in a step 56 while the state of charge SOC_Pb of the lead-acid battery 12 exceeds a lower bound of 30-40%, for example.

If, on the other hand, it is determined in step 55, that the lithium battery 6 is not empty, the lithium battery 6 is discharged in a step 57. If, during execution of step 56, a load draws more current than the lithium battery 6 can supply, a voltage at terminals of the lead-acid battery 12 drops below the end-of-charge voltage V_EOC_Pb and the lead-acid battery 12 will also be discharged.

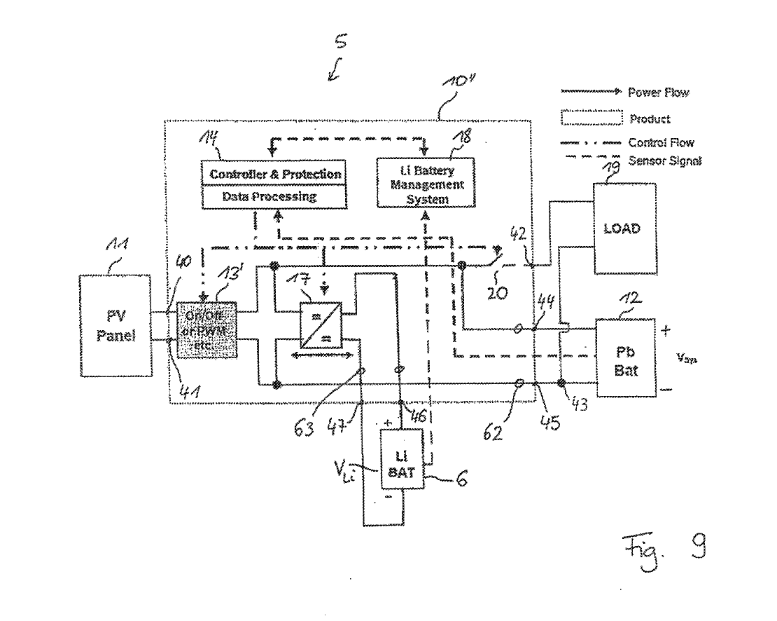

FIGS. 8 and 9 show further embodiments of a hybrid storage system 5, which are similar to the embodiment of FIGS. 1 to 3. According to the embodiments of FIGS. 8 and 9, the batteries 6 and 12 do not form part of the hybrid storage system 5 but are plugged into the hybrid storage system 5.

According to one embodiment of FIG. 8, the batteries 6, 12 are provided with voltage sensors and with connections for connecting the voltage sensors to the hybrid storage system 10′. The hybrid storage system 10′ is provided with a lead-acid battery voltage sensor 62 and a lithium battery voltage sensor 63. Furthermore, an input voltage sensor 64 and a supply current sensor 65 may be provided. The sensors, which are symbolized by open circles in FIG. 8, can be realized in various ways. For example, the sensors may be connected to two corresponding electric lines or to only one electric line. The current sensor may also be provided as magnetic field sensor.

The embodiment of FIG. 9 is similar to the embodiment of FIG. 8 but, in contrast to the preceding embodiment, the hybrid storage system 10″ comprises only one DC/DC converter 17, which is provided for an adjustment of a voltage at terminals of the lithium battery 6. Instead of the second DC/DC converter 13, and input current adjustment arrangement 13′ is provided, for example a controllable On/Off switch, a controllable pulse width modulation (PWM), an overvoltage protection or others. The current adjustment arrangement may be connected to the charge control system 14 by a control line, as shown in FIG. 9.

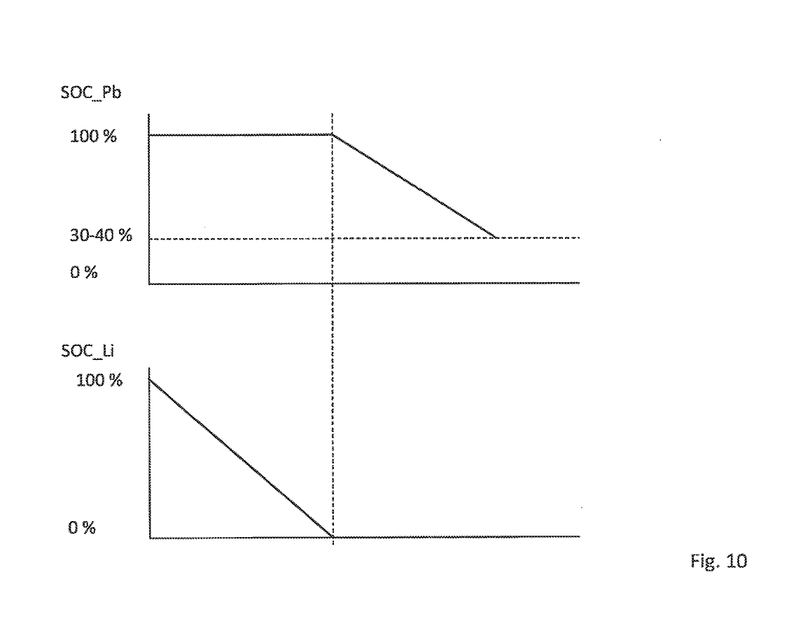

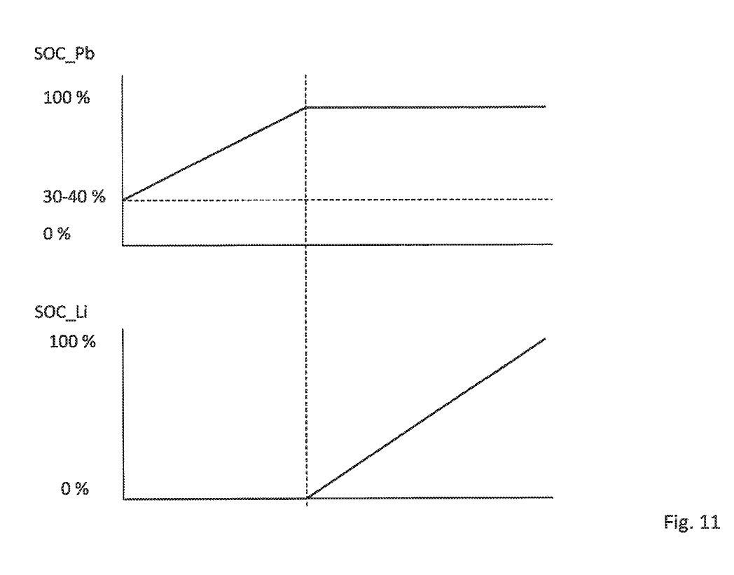

FIGS. 10 and 11 show idealized state of charge diagrams of the hybrid storage system of FIG. 1 during discharging and during charging. In FIGS. 10 and 11, the state of charge of the batteries is shown over time. The actual curves may differ in that the actual time dependence of the state of charge is not linear, or, in other words, in that the charge or discharge current is not constant.

FIG. 10 shows a discharge cycle for the hybrid storage system 10 of FIG. 1. In a first discharge phase, the lithium-ion battery 6 is connected to the load 19 and is discharged to a final discharge voltage, also known as “cutoff-voltage”. By way of example, the cutoff-voltage may amount to 3.3 volts. The scale of the vertical axis in FIG. 10 is chosen such that the final discharge voltage corresponds to a state of charge of 0%. During discharge of the lithium-ion battery 6, two-way DC/DC Converter 17 is controlled such that the lead-acid battery 12 is essentially kept at a constant state of charge.

The DC/DC converter 17 has a pre-determined power rating. The power rating and the state of charge of the lithium-ion battery 6 determines a maximum amount of power that the load 19 can draw from the lithium-ion battery 6. In one embodiment, the pre-determined power rating of the DC/DC converter is below a peak power demand of the load 19. If the power demand of the load 19 exceeds the pre-determined power rating, the load 19 draws current from the lead-acid battery 12 during the first discharge phase. This situation is shown in FIG. 6. In the situation shown in FIG. 10 the power demand of the load 19 does not exceed the power rating of the two-way DC/DC converter 17.

By way of example, the DC/DC converter 17 may have a pre-determined power rating of 500 W. If a peak demand of the load 19 exceeds 500 W, the voltage at the terminals of the lead acid battery 12 will drop below the open circuit voltage of the lead-acid battery 12, thereby producing a temporary discharge current from the lead-acid battery 12. The circuit structure of the hybrid storage device 10 provides a simple design for an overload function that meets peak power demands of the load 19. In a hybrid storage device according to the present specification, a feedback control and/or additional controlled switches are not required to provide additional power to the load 19 from the lead-acid battery 12 although they may be provided if desired.

According to one embodiment, the two-way DC/DC converter 17 is controlled such that, during the first discharge phase, the voltage at the lead-acid battery 12 is kept at or above the open circuit voltage of the lead-acid battery 12 at the beginning of the first discharge phase. Thereby, a discharge current from the lead-acid battery is zero or smaller than zero as long as a pre-determined power rating of the two-way DC/DC converter is not exceeded.

According to another embodiment, the two-way DC/DC converter 17 is controlled such that, during the first discharge phase, an average discharge current of the lead acid battery 12 is zero or smaller than zero, as long as a pre-determined power rating of the two-way DC/DC converter 17 is not exceeded. However, in a given instant there may be a temporary discharge current from the lead-acid battery 12 even though the pre-determined power rating of the two-way DC/DC converter 17 is not exceeded.

During a second discharge phase, the lead-acid battery 12 is connected to the load 19 and discharged while the lithium-ion battery 6 is kept at an essentially constant state of charge. In one embodiment a switch of the two-way DC/DC converter 17, such as the switch 29 of FIG. 3, is kept open such that the two-way DC/DC converter effectively acts as an open switch that prevents a discharge current from the lithium-ion battery 6. According to another embodiment, the two-way DC/DC converter 17 is controlled such that a voltage at terminals of the lithium-ion battery 6 is essentially equal to or greater than the open circuit voltage of the lithium-ion battery 6 at the beginning of the second discharge phase. In FIG. 10, a dashed vertical line marks the end of the first discharge phase and the beginning of the second discharge phase.

FIG. 11 shows a charge cycle for the hybrid storage system 10 of FIG. 1. In a first charge phase, the lead-acid battery is connected to a current source such as the photovoltaic module 11 and is charged while the lithium-ion battery 6 is essentially kept at a constant state of charge. In one embodiment, a switch of the two-way DC/DC converter 17 is kept open such that the two-way DC/DC converter effectively acts as an open switch that prevents a current from the lithium-ion battery. According to another embodiment, the two-way DC/DC converter 17 is controlled such that a voltage at terminals of the lithium-ion battery 6 is essentially equal to or greater than the open circuit voltage of the lithium-ion battery 6 at the beginning of the first charge phase.

In a second charge phase, the lithium-ion battery 6 is connected to the current source and is charged while a state of charge of the lead-acid battery 12 is kept essentially constant. In one embodiment, the two-way DC/DC converter 17 is controlled such that there is no discharge current from the lead-acid battery 12 on average. In particular this may comprises keeping a voltage at terminals of the lead-acid battery 12 essentially equal to or higher than the open circuit voltage of the lead-acid battery 12 at the beginning of the second charge phase.

In FIG. 11, the end of the first charge phase and the beginning of the second charge phase is marked by a dashed vertical line. By discharging the lithium-ion battery 6 first and by charging the lead-acid battery 12 first the charge level of the lead-acid battery 12 is kept high. Thereby, the aging processes of the lead-acid battery 12 are slowed down.

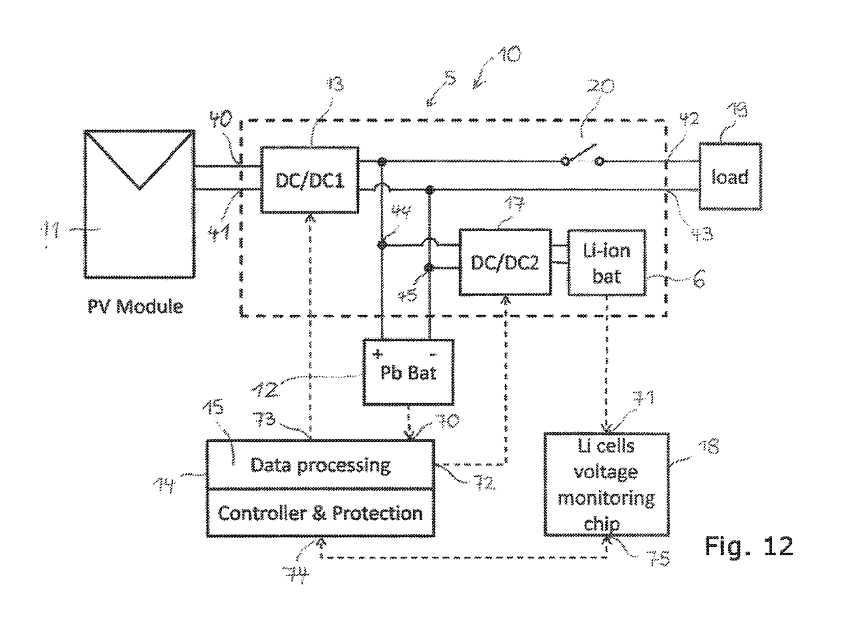

FIG. 12 shows a further view of the hybrid storage system 10 of FIG. 1. FIG. 12 illustrates a first sensing input 70 and a second sensing input 74 of the charge and discharge control system 14, Furthermore, FIG. 12 shows a first control output 72 and a second control output 73 of the charge and discharge control system 14.

The lithium cell voltage monitoring chip 18 comprises a sensing output 71 and a communication port 75. In the embodiment of FIG. 12, the second sensing input 74 of the charge and discharge control system 14 and the communication port 75 are provided for bidirectional communication. According to another embodiment, the charge and discharge control system 14 and the lithium cell voltage monitoring chip 18 each have an input and an output port which are provided for unidirectional communication between the charge and discharge control system 14 and the lithium cell voltage monitoring chip 18.

In the abovementioned description, details have been provided to describe the embodiments of the application. It shall be apparent to one skilled in the art, however, that the embodiments may be practised without such details. For example, there are various circuit arrangements for realizing the components of the hybrid storage system 10. These circuit arrangements may have additional components or other components with similar functions as those shown in the detailed embodiment. For example, the transistors are shown as n-type unipolar transistors in the embodiments. The skilled person will recognize, however, that the arrangement can also be realized with p-type transistors. Other modifications may arise, for example, from reversing the polarity of the batteries, placing voltage sensors at different locations etc.

The embodiments can also be described with the following lists of elements being organized into items. The respective combinations of features which are disclosed in the item list are regarded as independent subject matter, respectively, that can also be combined with other features of the application.

1: Hybrid battery-charging device (10) comprising
input terminals (40, 41) for connecting a photovoltaic panel,
first battery connections (44, 45) for connecting a lead-acid battery (12),
second battery connections (46, 47) for connecting a high-cycle chemical battery (6),
a two-way DC/DC converter (17), wherein a first terminal of the two-way DC/DC converter (17) is connected with the second battery connections (46, 47), and wherein a second terminal of the two-way DC/DC converter (17) is connected with the first battery connections (44, 45),
a charge and discharge control system (14), which is connected to the two way DC/DC converter (17) by a control line,
output terminals (42, 43) for connecting a load (19), wherein an input to the output terminals is derived from the first battery connections (44, 45).

2: Hybrid battery-charging device (10) according to item 1, further comprising
a control device (13) which is connected to the charge and discharge control system (14), wherein input terminals of the control device (13) are connected to the input terminals (40, 41), and wherein output terminals of the control device (13) are connected to input terminals of the DC/DC converter (17).

3: Hybrid battery-charging device (10) according to item 2, wherein the control device (13) comprises a pulse width modulation.

4: Hybrid battery-charging device (10) according to item 2 or item 3, wherein the control device (13) comprises a maximum power point tracker.

5: Hybrid battery-charging device (10) according to item 2 or item 3, wherein the control device (13) comprises a controllable switch (13′).

6: Hybrid battery-charging device (10) according to item 2 or item 3, wherein the control device (13) comprises a DC/DC converter (13′).

7: Hybrid battery-charging device (10) according to one of the preceding items, wherein the two-way DC/DC converter (17) comprises a buck-boost converter, a buck converter, a boost converter or another converter topology.

8: Hybrid battery-charging device (10) according to one of the preceding items, wherein the two-way DC/DC converter (17) comprises at least two semiconductor switches (29, 30), wherein respective input connections of the transistors (29, 30) are connected to the charge control system (14) via respective control lines.

9: Hybrid battery-charging device (10) according to one of the preceding items, comprising
first voltage measuring connections for connecting a first voltage sensor, the first voltage sensor being connected to terminals of the lead-acid battery (12) and the first voltage measuring connections being connected to the charge and discharge control system (14),
second voltage measuring connections for connecting a second voltage sensor, the second voltage sensor being connected to terminals of the high-cycle chemical battery and the second voltage measuring connections being connected to the charge and discharge control system (14).

10: Hybrid battery-charging device (10) according to item 1 or item 2, comprising a separate battery management system for the high-cycle chemical battery, the separate battery management system (18) being connected to the charge and discharge control system (14).

11: Hybrid storage system (5) with a hybrid charging device (10) according to one of the preceding items, further comprising a high-cycle chemical battery (6) which is connected to the second battery connections (46, 47).

12: Hybrid storage system (5) according to item 11, wherein the high-cycle chemical batter (6) comprises a lithium battery (6).

13: Hybrid storage system (5) according to item 11, further comprising a capacitor which is connected in parallel to the high-cycle chemical battery (6).

14: Hybrid storage system (5) according to one of the items 11 to 13, further comprising a lead-acid battery (12), the lead-acid battery (12) being connected to the first battery connections (44, 45).

15: Hybrid storage system (5) according to one of the items 11 to 14, further comprising a
a first voltage sensor which is connected to a terminal of the first battery (12) and to the charge and discharge control system (14),
a second voltage sensor which is connected to a terminal of the second voltage battery (6) and to the charge and discharge control system (14).

16: Method for charging a lead-acid battery (12) and a high-cycle chemical battery (6) of a hybrid storage system (5) by an electric power source (11),
charging the lead-acid battery (12) in a first battery charging phase until the lead-acid battery (12) has reached a first pre-determined state of charge,
charging the lead-acid battery (12) in a topping/boost/equalization phase until the lead-acid battery (12) has reached a second pre-determined state of charge,
charging the high-cycle chemical battery (6) in a third battery charging phase during which an essentially constant system voltage is applied to system terminals of the lead-acid battery (12) and the system voltage is converted, especially up-converted, into a charging voltage at terminals of the high-cycle chemical battery (6).

17: Method according to item 16, the equalization phase further comprising applying a voltage at the lead-acid battery that oscillates between a pre-determined lower voltage and a predetermined upper voltage.

18: Method for charging a hybrid storage system (5) according to item 16 or item 17, further comprising maintaining a mean voltage at terminals of the lead-acid battery (12) at an end-of-charge voltage of the lead-acid battery (12) during the equalization phase.

19: Method for charging a hybrid storage system (5) according to one of items 16 to 18, wherein, during the equalization phase, a system voltage at terminals of the lead-acid battery is controlled to be constant such that a charge current to the lead-acid battery decreases and a remaining charging power is transferred to the high-cycle chemical battery (6).

20: Method for charging a hybrid storage system (5) according to one of items 16 to 19, wherein the essentially constant system voltage that is applied to the system terminals during the charging of the high-cycle chemical battery (6) in the third battery charging phase is equal to a maximum open circuit voltage V_Fb_maxOC of the lead-acid battery (12).

21: Method for charging a hybrid storage system (5) according to one of items 16 to 20, wherein a decision for starting the equalization phase and a decision for starting the third battery charging phase is taken depending on a system voltage at terminals of the lead-acid battery.

22: Method for discharging a lead-acid battery (12) and a high-cycle chemical battery (6) of a hybrid storage system (5) the method comprising
supplying a load (19) with power by discharging a high-cycle chemical battery (6) via system terminals of a lead-acid battery (12) and maintaining the voltage at the system terminals essentially equal to a maximum open circuit voltage of the lead-acid battery (12), until the output voltage of the high-cycle chemical battery (6) has reached an end-of-discharge voltage of the high-cycle chemical battery (6),
discharging the lead-acid battery (12) until the voltage of the lead-acid battery (12) has reached an end-of-discharge voltage of the lead-acid battery (12).

23: Method according to item 22, wherein the steps of discharging the high-cycle chemical battery (6) and of discharging the lead-acid battery (12) are executed in parallel.

24: Hybrid battery-charging device (10) according to one of items 1 to 8, wherein the charge and discharge control system (14) comprises an arrangement for executing the steps of a method according to one of the items 16 to 23.

Furthermore, the embodiments can also be described with the following lists of elements being organized into items. The respective combinations of features which are disclosed in the item list are regarded as independent subject matter, respectively, that can also be combined with other features of the application.

1: A hybrid battery-charging device (10) comprising
input terminals (40, 41) for connecting a photovoltaic panel,
first battery connections (44, 45) for connecting a lead-acid battery (12),
second battery connections (46, 47) for connecting a high-cycle chemical battery (6),
a two-way DC/DC converter (17), wherein a first set of terminals of the two-way DC/DC converter (17) is connected with the second battery connections (46, 47), and wherein a second set of terminals of the two-way DC/DC converter (17) is connected with the first battery connections (44, 45),
output terminals (42, 43) for connecting a load (19), wherein an input to the output terminals (42, 43) is derived from the first battery connections (44, 45),
a charge and discharge control System (14), the charge and discharge control system (14) comprising
a first sensing input (70) for sensing a state of charge of the lead-acid-battery (12) (connected to the lead-acid battery (12),
a second sensing input (74) for sensing a state of charge of the high-cycle chemical battery (6),
a control output (72) for controlling the two-way DC/DC converter (17),
a controller unit (15),

wherein the charge and discharge control system {14) is operative to control the two-way DC/DC converter (17) such that the charging of the lead-acid battery (12) is provided if its state of charge is below a pre-determined threshold and that the charging of high-cycle chemical battery (6) is provided if its state of charge is below a pre-determined threshold and if the state of charge of the lead-acid battery (12) is above a pre-determined threshold.

2: A hybrid battery-charging device (10) comprising
input terminals (40, 41) for connecting a photovoltaic panel,
   first battery connections (44, 45) for connecting a lead-acid battery (12),
second battery connections (46, 47) for connecting a high-cycle chemical battery (6),
   a two-way DC/DC converter (17), wherein a first set of terminals of the two-way DC/DC converter (17) is connected with the second battery connections (46, 47), and wherein a second set of terminals of the two-way DC/DC converter (17) is connected with the first battery connections (44, 45),
output terminals (42, 43) for connecting a load (19), wherein an input to the output terminals (42, 43) is derived from the first battery connections (44, 45),
   a charge and discharge control system (14), the charge and discharge control system (14) comprising
a first sensing input (70) for sensing a state of charge of the lead-acid-battery (12) (connected to the lead-acid battery (12),
a second sensing input (74) for sensing a state of charge of the high-cycle chemical battery (6),
a control output (72) for controlling the two-way DC/DC converter (17),
a Controller unit (15), wherein the charge and discharge control system (14) is operative to control the two-way DC/DC converter (17) such that the discharging of the lead-acid battery (12) is provided if the state of charge of high-cycle chemical battery (6) is below a pre-determined threshold or if a power demand of the load exceeds a pre-determined power capability of the two-way DC/DC converter (17) and of the high-cycle chemical battery (6).

3: A hybrid battery-charging device (10) comprising
input terminals (40, 41) for connecting a photovoltaic panel,
first battery connections (44, 45) for connecting a lead-acid battery (12),
second battery connections (46, 47) for connecting a high-cycle chemical battery (6),
a two-way DC/DC converter (17), wherein a first set of terminals of the two-way DC/DC converter (17) is connected with the second battery connections (46, 47), and wherein a second set of terminals of the two-way DC/DC converter (17) is connected with the first battery connections (44, 45),
a one-way DC/DC converter (13) that is connected between the input terminals (40, 41) and the first battery connections (44, 45),
a high cycle chemical battery (6), terminals of the high cycle chemical battery (6) being connected to the second battery connections (46, 47),
output terminals (42, 43) for connecting a load (19), wherein an input to the output terminals (42, 43) is derived from the first battery connections (44, 45), a switch (20), the switch (20) being connected between the first battery connections (44, 54) and the output terminals (42, 43).

4: The hybrid battery-charging device (10) according to item 3, wherein the high-cycle chemical battery (6) comprises a lithium-ion battery.

5: The hybrid battery-charging device (10) according to item 3 or item 4, comprising a charge and discharge control system (14), the charge and discharge control system (14) comprising
a first sensing input (70) for sensing a state of charge of the lead-acid-battery (12) (connected to the lead-acid battery (12),
a second sensing input (74) for sensing a state of charge of the high-cycle chemical battery (6) (connected to the lithium battery),
a first control output (72) that is connected to the two-way DC/DC converter (14),
a second control output (73) that is connected to the one-way DC/DC converter (13),
a controller unit (15) that is connected to the first sensing input (70), to the second sensing input (45), to the first control output (37) and to the second control output (73).

6: The hybrid battery-charging device (10) according to item 5, comprising a voltage monitoring chip (18), the voltage monitoring chip (18) being connected between the high-cycle chemical battery (6) and the second sensing input (74).

7: The hybrid battery charging device (10) according to any of the items 3 to 6, wherein the charge and discharge control system (14) is operative to close a switch (29) of the two-way DC/DC converter (17) during the second discharge phase and during the first charge phase.

8: The hybrid battery charging device (10) according to any of the items 3 to 7, wherein the charge and discharge control system (14) is operative to discharge the high-cycle chemical battery (6) to a predetermined lower state of charge and to discharge the lead-acid battery (12) to a pre-determined discharged state of charge after the high-cycle chemical battery (6) has reached the predetermined lower state of charge.

9: The hybrid battery charging device (10) according any of items 3 to 8, wherein the charge and discharge control system (14) is operative to charge the lead-acid battery (12) to a first pre-determined upper state of charge and to charge the high-cycle chemical battery (6) to a second predetermined upper state of charge after the lead-acid battery (12) has reached the first predetermined upper state of charge.

1-12. (canceled)

13. A hybrid battery-charging device, comprising:
input terminals for connecting a photovoltaic panel;
first battery connections for connecting a lead-acid battery;
second battery connections for connecting a high-cycle chemical battery;
a two-way DC/DC converter, wherein a first set of terminals of the two-way DC/DC converter is connected with the second battery connections, and wherein a second set of terminals of the two-way DC/DC converter is connected with the first battery connections;
output terminals for connecting a load, wherein an input to the output terminals is derived from the first battery connections;
a charge and discharge control system, including:
a first sensing input for sensing a state of charge of the lead-acid-battery, and which is connected to the lead-acid battery;
a second sensing input for sensing a state of charge of the high-cycle chemical battery;
a control output for controlling the two-way DC/DC converter; and
a controller unit operative to control the two-way DC/DC converter so that the lead-acid battery is charged if its state of charge is below a pre-determined threshold and so that the high-cycle chemical battery is charged if its state of charge is below a pre-determined threshold and if the state of charge of the lead-acid battery is above a pre-determined threshold.

14. A hybrid battery-charging device, comprising:
input terminals for connecting a photovoltaic panel;
first battery connections for connecting a lead-acid battery;
second battery connections for connecting a high-cycle chemical battery;
a two-way DC/DC converter, wherein a first set of terminals of the two-way DC/DC converter is connected with the second battery connections, and wherein a second set of terminals of the two-way DC/DC converter is connected with the first battery connections;
output terminals for connecting a load, wherein an input to the output terminals is derived from the first battery connections;
a charge and discharge control system, including:
a first sensing input for sensing a state of charge of the lead-acid-battery, and which is connected to the lead-acid battery;
a second sensing input for sensing a state of charge of the high-cycle chemical battery;
a control output for controlling the two-way DC/DC converter; and
a controller unit operative to control the two-way DC/DC converter so that the lead-acid battery is discharged if the state of charge of high-cycle chemical battery is below a pre-determined threshold or if a power demand of the load exceeds a pre-determined power capability of the two-way DC/DC converter and of the high-cycle chemical battery.

15. A hybrid battery-charging device, comprising:
input terminals for connecting a photovoltaic panel;
first battery connections for connecting a lead-acid battery;
second battery connections for connecting a high-cycle chemical battery;
a two-way DC/DC converter, wherein a first set of terminals of the two-way DC/DC converter is connected with the second battery connections, and wherein a second set of terminals of the two-way DC/DC converter is connected with the first battery connections;
a one-way DC/DC converter connected between the input terminals and the first battery connections; and
a high cycle chemical battery having terminals connected to the second battery connections, output terminals for connecting a load, wherein an input to the output terminals is derived from the first battery connections, and a switch connected between the first battery connections and the output terminals.

16. The hybrid battery-charging device of claim 15, wherein the high-cycle chemical battery includes a lithium-ion battery.

17. The hybrid battery-charging device of claim 15, further comprising:
a charge and discharge control system, including:
a first sensing input for sensing a state of charge of the lead-acid-battery, and which is connected to the lead-acid battery,
a second sensing input for sensing a state of charge of the high-cycle chemical battery, and which is connected to the lithium battery,
a first control output connected to the two-way DC/DC converter,
a second control output connected to the one-way DC/DC converter, and
a controller unit connected to the first sensing input, to the second sensing input, to the first control output and to the second control output.

18. The hybrid battery-charging device of claim 17, further comprising:
a voltage monitoring chip, which is connected between the high-cycle chemical battery and the second sensing input.

19. The hybrid battery charging device of claim 15, wherein the charge and discharge control system is operative to close a switch) of the two-way DC/DC converter during the second discharge phase and during the first charge phase.

20. The hybrid battery charging device of claim 15, wherein the charge and discharge control system is operative to discharge the high-cycle chemical battery to a predetermined lower state of charge and to discharge the lead-acid battery to a predetermined discharged state of charge after the high-cycle chemical battery has reached the predetermined lower state of charge.

21. The hybrid battery charging device of claim 15, wherein the charge and discharge control system is operative to charge the lead-acid battery to a first pre-determined upper state of charge and to charge the high-cycle chemical battery to a second predetermined upper state of charge after the lead-acid battery has reached the first predetermined upper state of charge.

22. A method for discharging a hybrid storage system with a lead-acid battery and a high-cycle chemical battery, the lead-acid battery and the high-cycle chemical battery being connected in parallel and a two-way DC/DC converter being connected between terminals of the lead-acid battery and terminals of the high-cycle chemical battery, the method comprising:
providing an output voltage of the two-way DC/DC Converter so that a voltage at the terminals of the lead-acid battery is equal to or greater than a battery voltage of the lead-acid battery, so as to prevent discharge of the lead-acid battery and allow discharge of the high-cycle chemical battery, when it is detected that the high-cycle chemical battery has reached a pre-determined lower state of charge; and
controlling the two-way DC/DC converter so that that the high-cycle chemical battery is disconnected from the lead-acid battery.

23. A method for charging a hybrid storage system with a lead-acid battery and a high-cycle chemical battery, the lead-acid battery and the high-cycle chemical battery is connected in parallel and a two-way DC/DC converter being connected between terminals of the lead-acid battery and terminals of the high-cycle chemical battery, the method comprising:
controlling the two-way DC/DC converter so that an output voltage of the two-way DC/DC converter is higher than an open circuit voltage of the lead-acid battery, so as to allow charging of the lead-acid battery; and
controlling the two-way DC/DC converter so that the high-cycle chemical battery is disconnected from the lead-acid battery, so as to prevent charging of the high-cycle chemical battery.

24. The method for charging a hybrid storage system of claim 23, further comprising:
if it is detected that the lead-acid battery has reached an upper state of charge, performing the following:
controlling the two-way DC/DC converter so that a state of charge of the lead-acid battery is essentially maintained, and
controlling the two-way DC/DC converter so that an output voltage of the two-way DC/DC converter is higher than an open circuit voltage of the high-cycle chemical battery, so as to allow charging of the high-cycle chemical battery.
